(19) United States
(12) Patent Application Publication
(10) Pub. No.: US 2022/0099129 A1
(43) Pub. Date: Mar. 31, 2022

(54) Self-Punching Fastening Element

(71) Applicant: PROFIL Verbindungstechnik GmbH & Co. KG, Friedrichsdorf (DE)

(72) Inventors: Tobias Jene, Friedrichsdorf (DE); Amer Mahlme, Bad Homburg (DE)

(21) Appl. No.: 17/486,097

(22) Filed: Sep. 27, 2021

(30) Foreign Application Priority Data
Sep. 29, 2020 (DE) 102020125460.1

(51) Int. Cl. F16B 19/08; F16B 19/10; F16B 5/04

(52) U.S. Cl. CPC F16B 19/086; F16B 5/04; F16B 19/10

(57) ABSTRACT

The invention relates to a self-punching fastening element for connecting a first workpiece to a second workpiece. The fastening element comprises a ring section that surrounds an opening of the fastening element in a peripheral direction and that has a workpiece contact surface, which is bounded at a radial outer side by a punching edge, and a shaft section that is connected to the ring section by means of a coupling section, that is arranged coaxially with the opening, that extends from the side of the ring section remote from the workpiece contact surface, and that has an outer contour that is designed complementary to an inner contour of the opening such that the shaft section can be guided at least partly through the opening after a separation of the connection with the ring section. Furthermore, the invention relates to a component assembly, comprising a self-punching fastening element as well as a first workpiece and possibly a second workpiece, and to a method of manufacturing the component assembly.

The invention relates to a self-punching fastening element for connecting a first workpiece to a second workpiece, in particular wherein the workpieces are sheet metal parts. The first material and/or the second material can, however, generally also be plastic parts.

Fastening elements of this kind are generally known and are used extensively, for example, in automotive engineering. However, the technical effort is high, in particular on the connection of high-strength sheet metal parts to one another or on the connection of high-strength sheet metal parts to sheet metal parts of lower strength. High processing forces in particular have to be applied to establish such connections, which results in a high load on the tool used and on the workpieces to be connected. A reduced tool life and a structural impairment of the workpieces can be the result. In addition, the use of a fastening element having special properties can be required; the use of high-strength materials for the fastening element can, for example, be necessary, which makes the manufacture of the fastening element more difficult and more expensive.

The present invention has the underlying object of providing a fastening element for reliably connecting workpieces, in particular high-strength workpieces, in particular also to workpieces of a lower strength, said fastening element being characterized by a cost-effective manufacture.

The object is satisfied by a self-punching fastening element having the features of claim 1.

Specifically, the invention provides a self-punching fastening element for connecting a first workpiece to a second workpiece, in particular wherein the workpieces are sheet metal parts. The fastening element in accordance with the invention comprises a ring section that surrounds an opening of the fastening element in a peripheral direction and that has a workpiece contact surface, which is bounded at a radial outer side by a punching edge, and an engagement surface for a first setting device that is arranged at a side of the ring section remote from the workpiece contact surface. The fastening element further comprises a shaft section that is connected to the ring section by means of a coupling section, that is arranged coaxially with the opening, that extends from the side of the ring section remote from the workpiece contact surface, and that has an outer contour that is designed complementary to an inner contour of the opening such that the shaft section can be guided at least partly through the opening after a separation of the connection with the ring section, wherein an axial extent of the shaft section is greater than an axial extent of the ring section.

The fastening element in accordance with the invention therefore comprises two sections for connecting two workpieces, i.e. so-to-say two fastening components that adjoin one another in a longitudinal direction of the fastening element and that can be successively fastened to the first workpiece and the second workpiece in a two-stage fastening process. The fastening element in accordance with the invention can be fastened to a first workpiece during a press hardening process or during a hot shaping process, for example. Subsequently, a second workpiece, for example composed of a sheet metal material or a plastic material, can be fastened to said first workpiece by means of a second connection process, in particular without a heating.

The fastening element can be used to connect workpieces produced from any desired material, wherein advantageously at least one of the workpieces is a metal part, for example a sheet metal part. Both workpieces are preferably metal parts, wherein the first workpiece and the second workpiece can be produced from the same material, in particular metal, or from different materials, in particular different metals. At least one of the workpieces can be produced from a high-strength material, for example metal, and can have a strength of greater than 600 MPa, in particular greater than 1200 MPa and up to 2000 MPa, in particular even greater than 2000 MPa. For example, at least one of the workpieces can be a high-strength steel part. At least one of the workpieces can also be an aluminum component. Thus, the fastening element in accordance with the invention is particularly flexibly suitable for lightweight designs and mixed designs and can be used to easily and reliably connect workpieces having different material properties, in particular having different strengths, such that a great flexibility and bandwidth with regard to the usability of the fastening element result. The connection is in particular independent of the final strength of the workpieces used.

The fastening element itself can likewise be produced from any desired material, preferably from a metal. However, a production of the fastening element from high-strength metal, also on the insertion in high-strength metal sheets, is not absolutely necessary. A specific heat treatment or a specific coating to harden the fastening element is, as a rule, likewise not absolutely necessary and the risk of a hydrogen embrittlement of the fastening element can be avoided, while a simple and inexpensive manufacture is possible.

The ring section comprises an opening extending in an axial direction along the longitudinal direction of the fastening element. The opening can, for example, have a round cross-section, alternatively also an oval, elliptical, or polygonal cross-section. The workpiece contact surface extends in a radial direction of the fastening element and is arranged at an axial end of the fastening element remote from the shaft section. The punching edge surrounding the workpiece contact surface is configured such that, during the insertion of the fastening element into the first workpiece, it punches a hole for receiving the ring section into the workpiece. A pre-punching of the first workpiece is thus not necessary.

The shaft section adjoins the ring section in the axial direction and is connected to the ring section by means of the coupling section in a pre-assembly state of the fastening element. After a separation of the shaft section from the ring section, the former is movable along the longitudinal axis of the fastening element and can thus be guided through the opening. For this purpose, a cross-section of the shaft section is formed corresponding to a cross-section of the opening. For example, the cross-sectional surfaces can be at least substantially equal, wherein the cross-section of the shaft section can be slightly smaller, for example.

In the pre-assembly state, the shaft section can have a second engagement surface for a second setting device at an end region remote from the ring section, said second engagement surface serving to release the coupling of the shaft section and the ring section.

It is conceivable that the shaft section has a second punching edge, in particular a second punching edge that bounds the shaft section at the outer side in the region of the coupling section. The second punching edge can be provided to punch a hole for receiving the shaft section into a workpiece, in particular into the second workpiece.

A flexible use of the fastening element is possible for workpieces having different sheet metal thicknesses. It must be noted that the thickness of the first workpiece should not exceed the length of the shaft section so that a passing of the shaft section up to and into or through the second workpiece remains possible.

Advantageous embodiments of the invention can be seen from the dependent claims, from the description, and from the drawing.

In accordance with an embodiment, the workpiece contact surface and/or the engagement surface is/are annular and/or a basic shape of an outer contour of the ring section is substantially circular. The workpiece contact surface and the engagement surface can be oriented in parallel with one another. The fastening element can be designed rotationally symmetrical with respect to its longitudinal axis, whereby it can be manufactured and used in a particularly easy and inexpensive manner since the fastening element itself and/or the first setting device can be used at any desired angle of rotation with respect to the longitudinal axis.

Alternatively, the ring section can have an outer contour that deviates from the circular shape or ring shape and that is instead, for example, oval, elliptical, or polygonal. In this way, an effective security against rotation of the fastening element in the first workpiece can be achieved.

Alternatively or additionally, a radial outer surface of the ring section can have at least one feature providing security against rotation, in particular at least one recess and/or at least one elevated portion. Such a feature providing security against rotation can comprise one or more grooves, ribs, or a knurling, wherein the feature or features providing security against rotation can, for example, be arranged distributed over the outer contour of the ring section in the peripheral direction for a particularly effective security against rotation.

In accordance with a further embodiment, the workpiece contact surface is sectionally provided with an elevated portion that is in particular of annular design and/or that is arranged in a radially inwardly disposed region of the workpiece contact surface adjacent to or adjoining the opening. For example, the elevated portion can extend in a ring shape around the opening of the ring section, wherein it can in particular merge into the inner contour of the opening via a conically tapering slope.

If the workpiece contact surface is moved closer to the first workpiece during the setting process, the elevated portion of the workpiece contact surface first comes into contact with the workpiece. The elevated portion advantageously pre-bends the workpiece on the punching in of the ring section such that the punching edge subsequently coming into contact with the workpiece acts on a workpiece section that is bent and that is therefore under tension. The punching process can thus be facilitated. In addition, a punching slug can be reliably ejected from the first workpiece by the elevated portion projecting from the workpiece contact surface. For a secure connection of the first workpiece to the second workpiece, the elevated portion can serve as a counter-die or shaping punch during the fastening process, as will be explained in the following.

For a particularly reliable fastening, the shaft section can have at least one recess at its radial outer side, said at least one recess at least sectionally extending in the peripheral direction, in particular wherein the recess is a groove extending in the peripheral direction. The shaft section can advantageously also have a plurality of groove-like recesses that, for example, extend in parallel with one another and that are arranged distributed over a section or the total axial extent of the shaft section, for example. Only partly peripheral grooves can also be provided. Recesses are preferably arranged in a region of the shaft section that adjoins the ring section in the axial direction in a pre-assembly state of the fastening element and that in particular projects from the ring section at the side of the workpiece contact surface after a passing of the shaft section through the ring section. The recesses arranged in this region of the shaft section can receive any displaced material, in particular of the second workpiece, in an assembly state of the fastening element in order to ensure an effective fastening.

Such recesses can be omitted in an axial region of the shaft section that remains within the ring section in an assembly state of the fastening element. To securely fasten the shaft section in the ring section, for example by a press fit between an outer contour of the shaft section and the inner contour of the ring section, provision can be made that the shaft section expands conically from the coupling section to its end remote from the ring section. If necessary, the inner contour of the ring section can have a corresponding conical shape.

It is also conceivable that the shaft section at least sectionally has one or more axial recesses that can act as a security against rotation of the shaft section after the passing of the shaft section through the ring section. This at least one axial recess arranged along the longitudinal axis of the fastening element can likewise be groove-like, wherein in particular a plurality of axial recesses are arranged distributed over the shaft section in the peripheral direction.

For a fastening secure against rotation, the shaft section can alternatively or additionally have at least one elevated portion at its radial outer side, said at least one elevated portion at least sectionally extending in an axial direction, in particular wherein the elevated portion is a rib extending in the axial direction. Such an elevated portion can, for example, dig into a wall of the opening on the passing through of the ring section and can effectively prevent a rotation of the shaft section relative to the ring section. If the axially extending elevated portion extends in a region of the shaft section that projects beyond the ring section at the side of the workpiece contact surface in an assembly state, a security against rotation can also be effected with respect to the first and/or second workpiece.

The shaft section can advantageously have a radially expanded head section at its end remote from the ring section, said radially expanded head section at least sectionally projecting over the inner contour of the opening in a radial direction. The radially expanded head section can so-to-say serve as an axial abutment on the passing of the shaft section through the opening of the ring section, said axial abutment preventing the shaft section from being fully guided into or through the ring section. The radially expanded head section can simultaneously serve as a second engagement surface for a second setting device by means of which the shaft section can be guided through the ring section. It is particularly advantageous if, on the passing through of the ring section, the radially expanded head section finally at least regionally comes into engagement with the engagement surface for the first setting device. A force transmission from the second setting device to the ring section is then—exclusively or additionally—indirectly possible via the radially expanded head section.

In accordance with a construction of the fastening element that is particularly simple and inexpensive to manufacture from a design aspect, a base body of the shaft section has an at least substantially cylindrical shape, wherein the opening of the ring section can be at least substantially circular. Deviations from the cylindrical shape can, for example, be formed by recesses or elevated portions, in particular grooves or ribs, that contribute to a secure anchoring and/or security against rotation of the shaft section.

The coupling section can be designed such that a friction locking, a bond, and/or a form fit is/are established between the shaft section and the ring section. The connection between the ring section and the shaft section is in particular strong enough to captively fasten the shaft section to the ring section, for example, for a transport and during the punching in of the fastening element by means of a first setting device. However, the connection should be sufficiently easy to separate, for example by a second setting device, for the passing of the shaft section through the ring section.

Such a connection can be produced in various ways, for example by a friction locking by means of a clamping connection or a press fit, by shrinking the ring section onto the shaft section, by pressing the shaft section into the ring section, by a bond by means of gluing or soldering, by a form fit by means of an undercut that can be sheared off, latching noses, a clip connection, or by further generally known connection types. A combination of different connection types is also possible.

For a particularly flexible usability of the fastening element, the shaft section and the ring section can comprise different materials. For example, the ring section can be optimized for a connection to the first workpiece composed of a first material and the shaft section can be optimized for a connection to the ring section, on the one hand, and to the second workpiece composed of a second material, on the other hand. In particular in mixed designs, wherein the material of the first workpiece and the second workpiece are different from one another, a particularly reliable connection can be achieved in this way.

For a particularly simple and inexpensive manufacture of the fastening element, the shaft section and the ring section are formed in one piece in accordance with an embodiment. In this case, the shaft section and the ring section are formed from the same material. The coupling section of the fastening element can be a desired breakage point that may have one or more apertures or zones of weakness to facilitate the separation of the shaft section and the ring section.

A further subject of the invention is a component assembly comprising a first workpiece into which the ring section of a fastening element in accordance with at least one of the embodiments described above is punched. A punching slug punched out of the first workpiece is disposed of. The self-punching ring section is reliably connected to the first workpiece. The shaft section and the ring section are still coupled to one another by means of the coupling section and the shaft section adjoins the engagement surface of the fastening element in the longitudinal direction of the fastening element.

In accordance with an advantageous embodiment, a surface of the first workpiece remote from the fastening element prior to the punching in is arranged substantially flush with the workpiece contact surface in a region adjacent to or adjoining an opening in the first workpiece produced by the punching in. The punch-in direction advantageously coincides with the longitudinal direction of the fastening element and corresponds to the direction in which the self-punching fastening element is acted on by a press-in force during the punching in. Thus, viewed from the shaft end to the ring end of the fastening element, a side of the first workpiece remote from the shaft end and the workpiece contact surface are aligned with one another in the longitudinal direction, while an elevated portion of the workpiece contact surface—if one is provided—projects beyond this side of the first workpiece in the axial direction.

To connect the first workpiece and a second workpiece to one another, the second workpiece can now advantageously be placed against the workpiece contact surface of the fastening element at this side remote from the shaft section and, in the case of sheet metal parts in particular in parallel with the first workpiece, against the component assembly and can then be fastened thereto.

The component assembly can further comprise a second workpiece that contacts the workpiece contact surface, wherein the connection of the shaft section and the ring section provided by the coupling section is separated and the shaft section is arranged in the opening of the ring section such that an end of the shaft section projects into the second workpiece or projects through the second workpiece. The second workpiece can thus be connected to the shaft section and/or the ring section in a form-fitted and/or force-fitted manner. For a particularly reliable connection, the shaft section is in particular received in the ring section in a form-fitted and/or force-fitted manner.

In accordance with a further embodiment, a surface of the second workpiece remote from the ring section has a recess, in particular an annular recess, that is arranged radially outside and adjacent to the end of the shaft section projecting into the second workpiece or projecting through the second workpiece. Such a recess can, for example, be produced by a die, in particular a die of a second setting device. The material displaced from the recess can contribute to a secure connection of the first and second workpieces by the fastening element.

Material of the second workpiece is in particular urged, for example by the effect of a die and/or by an elevated portion on the workpiece contact surface, into at least one recess that is arranged at a radial outer side of the shaft section. The material can also be urged into a plurality of recesses of the ring section and/or of the shaft section or into cut-outs remaining between the ring section and the shaft section such that a particularly reliable fastening of the workpieces is achieved that may be secure against rotation depending on the design of the recesses.

The material of the first workpiece can be stronger than the material of the second workpiece at least in a region around the fastening element, wherein in particular the first workpiece comprises steel, preferably high-strength steel, in this region and the second workpiece comprises aluminum in this region. The first workpiece can thus contribute to a particularly stable anchoring of the fastening element and the second workpiece. The strength of the first workpiece is preferably in the range from 800 to 2000 MPa, particularly preferably in the range from 1200 to 2000 MPa. The strength of the second workpiece is preferably in the range from 80 to 600 MPa.

The invention further relates to a method of manufacturing a component assembly in accordance with at least one of the embodiments described above. The method at least comprises the steps of (1) providing a first workpiece; and (2) punching a ring section of a fastening element in accordance with at least one embodiment described above into the first workpiece while producing a punching slug, wherein a first setting device acts on the engagement surface of the ring section on the punching in.

The punching in can take place during or subsequently to a press hardening of the first workpiece.

The first setting device can comprise a punch and a die, wherein the punch of the first setting device advantageously has a cut-out for the shaft section of the fastening element and a contact surface that can be brought into engagement with the engagement surface of the ring section. By pressing down the punch along a punch-in direction, which in particular coincides with the longitudinal direction of the fastening element, the ring section can be acted on by a press-in force that in particular acts perpendicular to a surface of the first workpiece. A hole required for fastening the fastening element can thus be produced in the first workpiece by means of the punching edge of the ring section. The first workpiece therefore does not need to have a prefabricated hole for the attachment of the fastening element. The die can have a passage opening, in particular a central passage opening coaxial with the punch, through which the punching slug is disposed of.

In accordance with an embodiment, the workpiece can be at least locally heated prior to the insertion of the fastening element, in particular to a temperature of more than 500° C., more than 600° C., more than 700° C., more than 800° C., more than 900° C., or more than 1000° C., for example up to 1030° C. During the insertion of the fastening element, the temperature can be lower than the maximum temperature reached on the heating of the workpiece and can, for example, be between 500° C. and 800° C. The heating of the workpiece can simplify the punching-in process, wherein the temperature of the first workpiece can advantageously be suitably selectable in dependence on the materials used of the workpiece and/or the fastening element. A fastening element can thus advantageously be inserted into a workpiece whose strength exceeds that of the fastening element in the unheated state. For example, the heating of the first workpiece can take place as part of a press hardening process or hot shaping process.

In this way, the insertion of fastening elements, such as punch rivets, into metal sheets, generally becomes possible, said metal sheets being of high strength, in particular in the cooled down again state, and having a strength of greater than 600 MPa, in particular greater than 1200 MPa and up to 2000 MPa or even greater than 2000 MPa, for example. At the same time, the formation of microcracks in the workpiece is effectively avoided by the heating. Since the workpiece contracts on the cooling down after the punching process and thus exerts a stabilizing clamping effect onto the punched-in fastening element, a particularly stable and reliable connection results.

A second workpiece can be provided subsequently to at least one of the above-described steps of the method, in particular after the punching of the fastening element into the first workpiece, such that said second workpiece is in contact with the workpiece contact surface of the ring section punched into the first workpiece, wherein the shaft section is subsequently pressed through the opening of the ring section and against the second workpiece by means of a second setting device such that an end of the shaft section projects into the second workpiece or projects through the second workpiece. The second setting device can comprise a second punch and a second die, wherein the punch in particular acts on the shaft section, for example, via a second engagement surface that is associated with the head section of the shaft section. In addition, the second setting device can comprise a downholder that fixes the first workpiece with the ring section punched therein against the second die and/or the second workpiece. For example, the downholder can have a ring-shaped cross-section and can be positioned around the fastening element. By applying a press-in force to the shaft section, in particular a press-in force acting along the longitudinal direction of the shaft section, the coupling section is preferably first separated so that the shaft section becomes movable relative to the ring section and the shaft section is subsequently guided through the ring section.

In accordance with an embodiment of the method, the second workpiece is not heated. The second workpiece is in particular attached to the first workpiece with the punched-in ring section approximately at room temperature or at a temperature that is typically present under the given production conditions. No active heating of the second workpiece is in particular provided, wherein a (comparatively slight) heating due to the punching process itself is not ruled out.

A punching slug is preferably punched out of the second workpiece on the pressing of the shaft section into the second workpiece. To dispose of the second punching slug, the second die of the second setting device can have a corresponding opening that can also receive the shaft section possibly passing through the second workpiece.

A complete penetration of the second workpiece and the punching out of a punching slug through the shaft section is not absolutely necessary to establish a stable connection of the first workpiece to the second workpiece. For example, provision can be made that the shaft section is pressed into the material of the second workpiece without penetrating it, wherein a reshaping of the shaft section, for example a radial expansion within the second workpiece, which ensures an anchoring of the shaft section in the second workpiece, can be provided. In many cases, a penetration of the second workpiece with or without an expansion of the shaft section is advantageous, however.

The second setting device in particular first acts on the shaft section to press said shaft section against the second workpiece until the shaft section has reached a desired end position, in particular relative to the ring section. The second setting device subsequently acts on the ring section, in particular via the engagement surface, to press the ring section against the second workpiece. For this purpose, the punch of the second setting device can have a contact section for contacting the fastening element that is designed such that, at the start of the second setting process, it contacts a second engagement surface of the fastening element, which is in particular arranged at the shaft section, by means of a first region of the contact section and applies a press-in force to the shaft section until the latter has reached the desired end position relative to the ring section or in the ring section. The contact section of the second punch can further have a second region that in particular surrounds the first region at the radial outer side and that, on reaching the relative end position between the shaft section and the ring section, contacts the ring section, in particular the engagement surface, and applies a press-in force in the direction of the second workpiece to the ring section. The first region of the second punch in this respect advantageously remains in engagement with the shaft section so that the relative alignment of the shaft section and the ring section is maintained.

Alternatively, provision can be made that the second punch only has a first region described above that cooperates with a head section of the shaft section. In the desired end position of the shaft section relative to the ring section, the head section of the shaft section can come into engagement with the ring section, in particular with the engagement surface, so that on a further application of a press-in force to the shaft section by the second punch, the ring section is so-to-say taken along by the shaft section in the direction of the second workpiece and is pressed onto the latter, while the shaft section and the ring section at least substantially no longer move relative to one another.

The second workpiece can be disposed on a die on the pressing in of the shaft section, said die having an elevated portion that projects from a support surface for the second workpiece and that has a radial inner contour that is disposed outside the outer contour of the shaft section in the radial direction, in particular wherein material of the second workpiece is urged by the die against the shaft section and possibly into at least one recess that is arranged at a radial outer side of the shaft section, wherein in particular an elevated portion of the workpiece contact surface acts as a counter-die to urge material of the second workpiece into the at least one recess that is arranged at the radial outer side of the shaft section. The elevated portion projecting from the support surface can, for example, be ring-shaped, wherein the inner contour of the elevated portion can slope conically at the radial inner side, i.e. in the direction of the outer contour of the shaft section, in the direction of an opening of the die. The elevated portion of the die can in particular displace the material of the second workpiece when the ring section is pressed against the second workpiece at the side of the second workpiece remote from the die. The workpiece contact surface or an elevated portion of the workpiece contact surface corresponding to the elevated portion on the die can act as a counter-die or a shaping punch to urge material of the second workpiece into at least one recess of the shaft section and, optionally, into conically sloping regions of the elevated portions on the die and/or the workpiece contact surface.

The first setting device and the second setting device preferably act coaxially with respect to the longitudinal axis of the fastening element and in the same punch-in direction.

The invention will be described in the following purely by way of example with reference to a possible embodiment and to the enclosed drawing. There are shown:

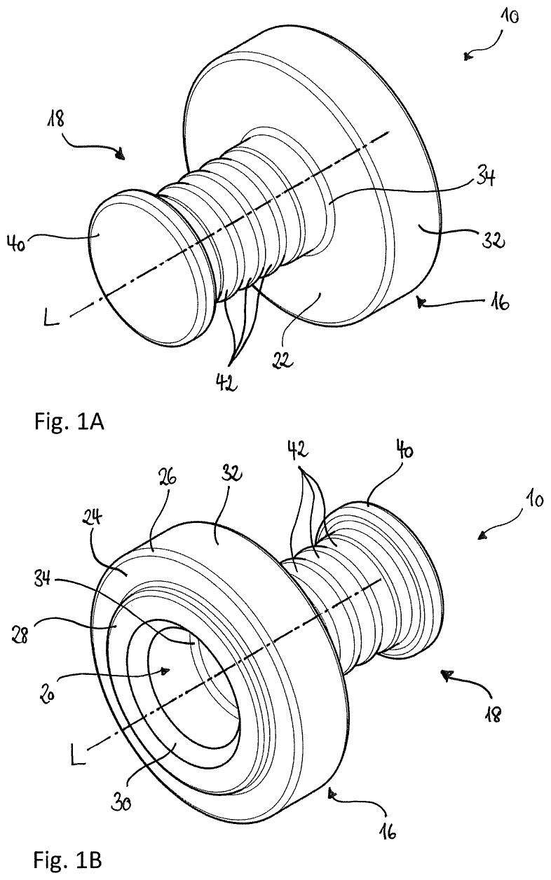

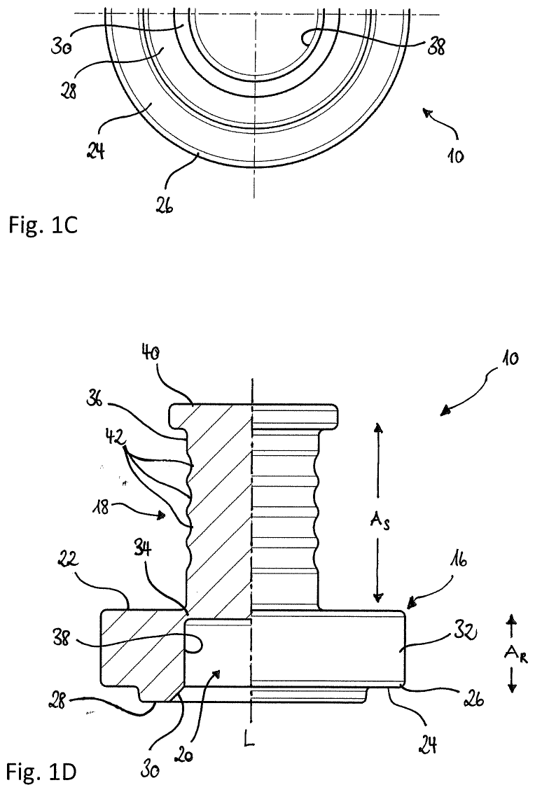

FIG. 1A a first perspective view of a fastening element in accordance with the invention;

FIG. 1B a second perspective view of the fastening element of FIG. 1;

FIG. 1C an axial end face view of the ring section of the fastening element of FIG. 1;

FIG. 1D a side view and a cross-sectional view of the fastening element of FIG. 1;

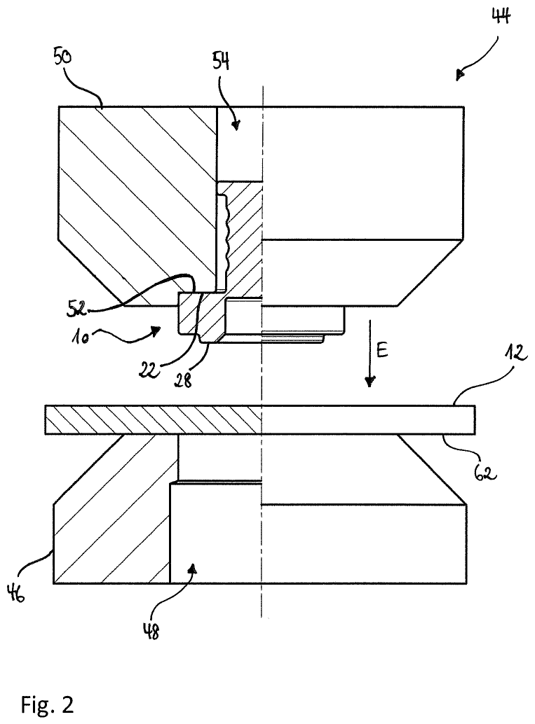

FIG. 2 the fastening element of FIGS. 1A-1D and a first setting device prior to the insertion of the fastening element into a first workpiece;

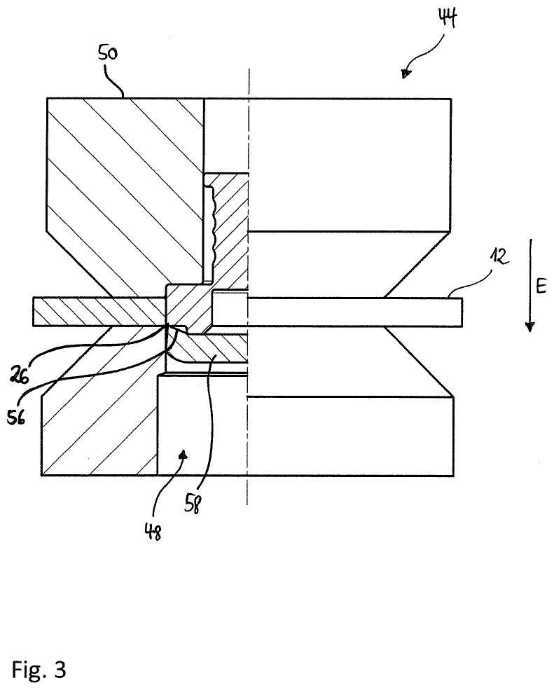

FIG. 3 the fastening element of FIGS. 1A-1D and the first setting device during the punching of the fastening element into the first workpiece;

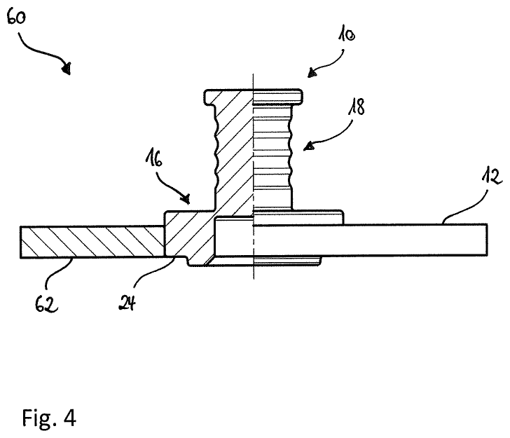

FIG. 4 a sectional view of an embodiment of the component assembly in accordance with the invention, comprising the first workpiece and the punched-in fastening element of FIG. 1;

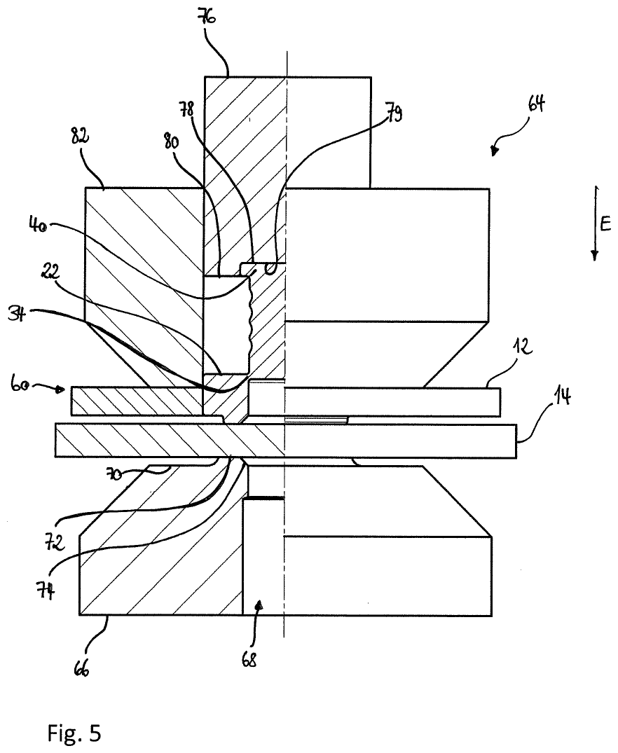

FIG. 5 the component assembly of FIG. 4 and a second setting device prior to the connection to a second workpiece;

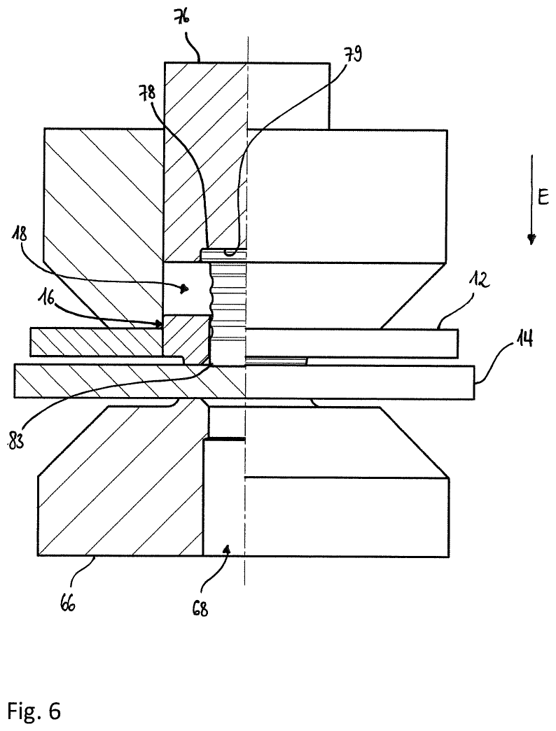

FIG. 6 the component assembly of FIG. 4 and the second setting device during the passing of the shaft section through the ring section;

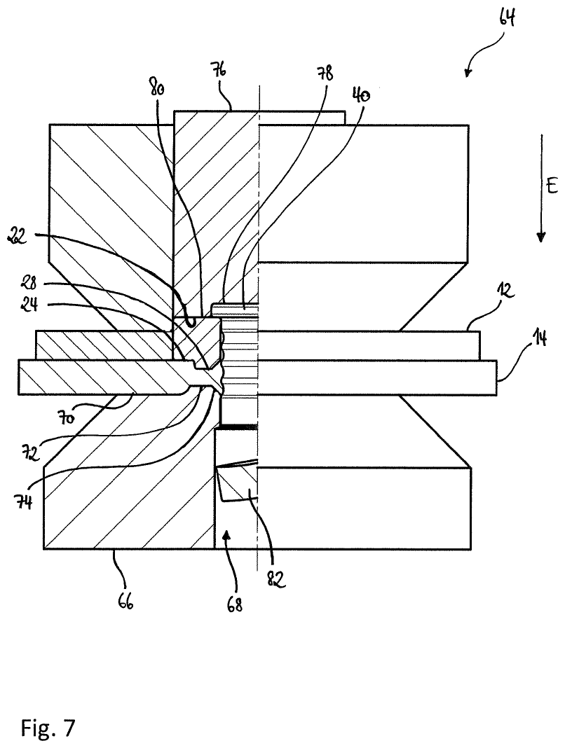

FIG. 7 the component assembly of FIG. 4 and the second setting device during the connection to the second workpiece; and

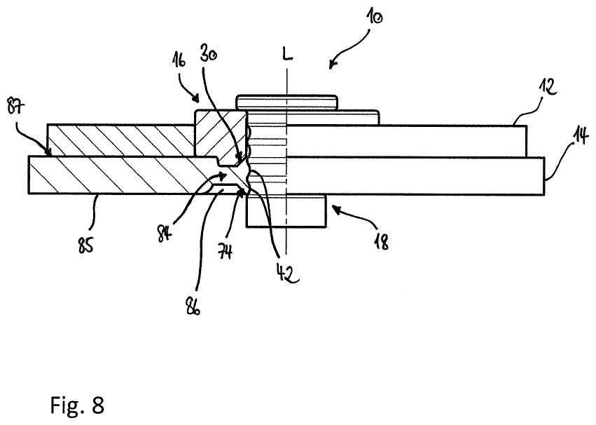

FIG. 8 the component assembly of FIG. 7, comprising the first workpiece, the second workpiece, and the fastened fastening element.

FIG. 1A shows a self-punching fastening element 10 composed of a metal for connecting a first workpiece 12 (see FIG. 2) and a second workpiece 14 (see FIG. 5). The fastening element comprises a ring section 16 and a shaft section 18 that are coaxially arranged along a longitudinal axis L of the fastening element 10.

The ring section 16 has a circular outer contour in the manner of a circular ring and surrounds a circular axial opening 20 in the peripheral direction (see FIG. 1B). On its side facing the shaft section 18, the ring section 16 has an annular engagement surface 22 (FIG. 1A) extending in the radial direction for a first setting device 44 (see FIG. 2). An annular workpiece contact surface 24 is arranged on the side of the ring section 16 remote from the shaft section 18 and the engagement surface 22 and is at least sectionally aligned in parallel with the engagement surface 22.

The workpiece contact surface 24 is bounded at the radial outer side by a punching edge 26 that is provided to punch a hole into the first workpiece 12, into which the fastening element 10 or the ring section 16 is inserted, on the punching in of the fastening element 10.

At the radial inner side, the workpiece contact surface 24 has an elevated portion 28 that is of annular design in the present embodiment and that has approximately half the radial width of the workpiece contact surface 24. The elevated portion 28 is radially adjacent to the opening 20, with the transition from the opening 20 to the elevated portion 28 being formed as a transition cone 30.

The ring section 16 of the fastening element 10 shown here is rotationally symmetrical about the longitudinal axis L. However, the ring section 16 can generally also have an outer contour differing from the ring shape and can, for example, have an oval or polygonal cross-section. An effective security against rotation of the ring section 16 after the insertion into a first workpiece 12 can, for example, be achieved by such an alternative embodiment. A radial outer surface 32 of the ring section 16 can alternatively or additionally also be provided with one or more features providing security against rotation, for example, elevated portions or recesses (not shown). The formation of grooves, in particular axial grooves, ribs, channels or a knurling of the radial outer surface 32 is conceivable.

On the side of the ring section 16 remote from the workpiece contact surface 24, the shaft section 18 adjoins the ring section 16 in the axial direction of the fastening element 10, with the shaft section 18 being arranged coaxially with the opening 20 of the ring section 16. In the embodiment example shown, the shaft section 18 has a round cross-sectional surface and a substantially cylindrical shape.

The shaft section 18 is connected to the ring section 16 by means of a coupling section 34 (see FIG. 1D). In the embodiment shown, the ring section 16 and the shaft section 18 are formed in one piece, wherein the coupling section 34 comprises a kind of bridge between the ring section 16 and the shaft section 18, said bridge being composed of the same material as the ring section 16 and the shaft section 18.

The coupling section 34 can generally also be designed such that the shaft section 18 is fastened to the ring section 16 in a friction-locked or form-fitted manner, for example by clamping or by a snap-in connection. In this case, the ring section 16 and the shaft section 18 can also be produced from different materials. In any case, the coupling section 34 is formed as a kind of desired breakage point of the fastening element 10 at which the ring section 16 can be separated in a targeted manner from the shaft section 18.

The shaft section 18 extends from the ring section 16 to its end remote from the ring section, where it has a radially expanded head section 40. The radially expanded head section 40 projects in the radial direction over an outer contour 36 of the shaft section 18, on the one hand, and over an inner contour 38 of the opening 20 of the ring section 16, on the other hand.

The outer contour 36 of the shaft section 18 is designed such that it is complementary to an inner contour 38 of the opening 20 of the ring section 16. In the embodiment example shown (see FIG. 1D), the inner contour 38 or the inner diameter of the circular opening 20 and the outer contour 36 or the outer diameter of the substantially cylindrical shaft section 18 correspond to one another such that the shaft section 18 can be received in the opening 20 after a separation of the coupling section 34.

When the coupling provided by the coupling section 34 is canceled, the shaft section 18 can be guided through the ring section 16. Since an axial extent A_{S} of the shaft section 18 is greater than an axial extent A_{R} of the ring section 16, the shaft section 18 can be guided through the opening 20 until it exits from the ring section 16 again at the side of the workpiece contact surface 24 of the ring section 16. At the side of the engagement surface 22, the shaft section 18 can be guided through the opening 20 of the ring section until the radially expanded head section 40 comes into engagement with the engagement surface 22 of the ring section 16 and a further axial displacement of the shaft section 18 relative to the ring section 16 is prevented. The radially expanded head section 40 thus serves as an axial abutment for the shaft section 18 (see FIG. 7).

The shaft section 18 has a plurality of channel-like or groove-like recesses 42 at its outer contour that extend in the peripheral direction. As becomes clear from FIG. 7 and FIG. 8, these recesses enable a particularly effective axial pull-out security of the fastening element 10 in an assembly state on the connection of two workpieces 12 and 14. To form a security against rotation, the shaft section 18 can alternatively or additionally also have recesses or elevated portions that at least sectionally extend in the axial direction, for example, at least one channel or rib that digs into the inner wall of the opening 20 and/or into one of the workpieces 12 and 14 on the penetration of the ring section 16.

The fastening element 10 is punched into the first workpiece 12 by means of a first setting device 44, as shown in FIGS. 2 to 4. For this purpose, the fastening element 10 described above is led up to the first workpiece along a punch-in direction E in parallel with the longitudinal axis L of the fastening element in accordance with FIG. 2. The first setting device 44 comprises a die 46 having a passage opening 48; and a punch 50 having a contact surface 52 that can be brought into engagement with the engagement surface 22 of the ring section 16 of the fastening element 10. To receive the shaft section 18, the punch 50 has a cut-out 54 so that a punch-in force exerted by the punch 50 only acts on the ring section 16, but not on the shaft section 18.

In the embodiment example shown, the first workpiece 12 is a metal sheet and is specifically produced from a high-strength steel. To reduce the required punch-in force and to avoid or at least minimize the initiation of microcracks in the high-strength first workpiece 12 on the punching in of the fastening element 10, the first workpiece 12 is heated to a sheet metal temperature of approximately 730° C. at least in a punching-in region. The heating process can in particular take place as part of a press hardening process. In this respect, the first workpiece can, for example, be heated to a temperature of approximately 1030° C. and then, at a workpiece temperature of approximately 730° C., the fastening element 10 can be inserted into the first workpiece 12. In this way, a fastening element 10 can be introduced into the high-strength first workpiece 12 that is not itself produced from a high-strength material, but is a simple steel part, for example. The temperature at which the first workpiece 12 is preheated can be adapted to its material properties. The first workpiece 12 can therefore, for example, achieve its desired high-strength material properties after the hot shaping process and the punching in of the fastening element 10.

For the punching into the heated first workpiece 12, the fastening element 10 is brought into contact with the first workpiece 12, with the workpiece contact surface 24 at the front, along the punch-in direction E by a relative movement of the punch 50 and die 46 directed toward one another, whereby first the elevated portion 28 of the workpiece contact surface 24 comes into contact with the first workpiece 12. The elevated portion 28 already bends the first workpiece in the punch-in direction due to the applied punch-in force and thus produces a stress in the metal sheet. Finally, with a continued punch-in movement, the punching edge 26 comes into contact with the preloaded workpiece section 56 so that the first workpiece 12 is cut through in the region of the punching edge 26 while producing a punching slug 58 and the ring section 16 of the fastening element 10 is punched into the heated first workpiece 12 (see FIG. 3). The punching slug 58 is disposed of through the passage opening 48 of the die, with the elevated portion 28 of the workpiece contact surface 24 contributing as a displacement structure to the reliable ejection of the punching slug 58.

FIG. 4 shows the resulting first component assembly 60 that comprises the first workpiece 12 into which the ring section 16 of the fastening element 10 is punched. The surface 62 of the first workpiece 12 remote from the fastening element 10 prior to the punching in, that is the lower surface 62 of the first workpiece 12 in accordance with FIG. 4, is aligned flush with the adjoining workpiece contact surface 24 of the fastening element 10 punched into the first workpiece 12.

The first component assembly 60 is removed from the first setting device 44 and cooled down to the environmental temperature, for example to approximately 20° C. On the cooling down, the first workpiece 12 contracts so that the workpiece 12 exerts a clamping effect onto the fastening element 10 and the connection of the ring section 16 to the first workpiece 12 is additionally improved.

In the further process, the first workpiece 12 of the first component assembly 60 is connected to the provided second workpiece 14 by means of a second setting device 64, as is shown in FIGS. 5 to 8. In the embodiment example shown, the second workpiece 14 is likewise a sheet metal part produced from metal (e.g. an aluminum sheet). The material of the first workpiece 12 therefore has a higher strength than the material of the second workpiece 14; the first workpiece 14 can in particular also be a plastic part. The second workpiece 14 is preferably composed of a ductile material so that it is deformable in a suitable manner (see below). It is generally also conceivable that the second workpiece 14 is produced from a plastic.

The second setting device 64 is shown in FIG. 5 and comprises a second die 66 having a circular second passage opening 68 and a support surface 70 for the second workpiece 14 arranged around the second passage opening 68. An annular elevated die portion 72, which projects from the support surface 70 and which merges into the second passage opening 68 via a conical region 74, is arranged around the second passage opening 68. The second setting device furthermore comprises a second punch 76 that comprises a first contact region 78 and a second contact region 80, wherein the first contact region 78 is in engagement with a second engagement surface 79 on the radially expanded head section 40 of the shaft section 18 and the second contact region 80 is in engagement with the engagement surface 22. The second setting device 64 further comprises a downholder 82 for fixing the first component assembly 60.

FIG. 5 shows how the second workpiece 14 is provided for connecting to the first component assembly 60 on the support surface 70 of the second die and in particular on the elevated die portion 72 projecting therefrom. The first component assembly 60 is positioned in the second setting device 64 such that the workpiece contact surface 24 of the ring section 16 and in particular the elevated portion 28 of the workpiece contact surface 24 contact the second workpiece 14. The second workpiece 14 is therefore clamped between the elevated portion 28 of the workpiece support surface 24 and the elevated die portion 72 at the start of the second setting process, wherein the second workpiece 14 is arranged spaced apart from both the first workpiece 12 and the support surface 70 outside the region of the elevated portions 28 and 72.

Like the first setting device 44, the second setting device 64 acts on the fastening element 10 coaxially to the longitudinal axis L. The downholder 82 fixes this arrangement. The second punch 76 is initially only in engagement with the second engagement surface 79 of the shaft section 18 by means of the first contact region 78 so that a punch-in force produced by the second setting device 64 only acts on the shaft section 18, but not on the ring section 16. An active heating of the second workpiece 14 is not provided.

FIG. 6 shows how the fastening element 10 for connecting the first and second workpieces 12, 14 is acted on by a punch-in force in the punch-in direction E by a relative movement of the second punch 76 and the second die 66 directed toward one another. Said punch-in force effects a separation of the shaft section 18 and the ring section 16 at the desired breakage point of the coupling section 34 so that the shaft section 18 is subsequently guided along the punch-in direction E through the opening 20 of the ring section 16. In the course of the pressing in, the end of the shaft section 18 remote from the radially expanded head section 40 is pressed onto the second workpiece 14, wherein a punching slug 82 is punched out of the aluminum sheet of the second workpiece 14 by means of a second punching edge 83 of the shaft section 18 produced by the separation of the coupling and is ejected through the second passage opening 68 of the second die 66.

The shaft section 18 is then pressed further through the opening 20 of the ring section 16 until it has reached the desired end position relative to the ring section 16. In the embodiment example shown, this end position is reached when the radially expanded head section 40 of the shaft section 18 has been brought into contact with the engagement surface 22 of the ring section 16 by the relative movement of the punch 76 and the die 66 of the second setting device 64.

At this moment, the second contact region 80 of the punch 76 likewise comes into engagement with the engagement surface 22 so that the punch-in force of the second setting device 64 also acts on the ring section 16 via the engagement surface 22 on the further pressing in and presses said ring section 16 against the second workpiece 14 along the punch-in direction E, while the relative position of the shaft section 18 and the ring section 16 remains constant since the second punch 76 also continues to apply the punch-in force to the shaft section 18 via the first contact region 78. At this point in time, the shaft section 18 is already arranged in the opening 20 of the ring section 16 such that an end of the shaft section 18 projects into the second workpiece 14 or, as in the shown embodiment example in accordance with FIGS. 6 and 7, projects through the second workpiece 14.

As soon as the punch 76 also applies the punch-in force to the ring section 16, the workpiece contact surface 24 of the ring section 16 is pressed against the second workpiece 14 contacting it, on the one hand, while, on the other hand, the second workpiece 14 is pressed against the contact surface 70 of the second die 66 and the elevated die portion 72. Due to the effect of the elevated die portion 72 and the elevated portion 28 of the workpiece contact surface 24 of the ring section 16, which so-to-say acts as a counter-die, material of the second workpiece 14 is pressed into the recesses 42 arranged at the radial outer side of the shaft section 18 since it is displaced from a tapering region 84 of the second workpiece 14 disposed between the elevated portion 28 and the elevated die portion 72. Thus, on the lower surface 85 of the second workpiece 14 remote from the ring section 16, a recess 86 corresponding to the elevated die portion 72 is formed that is annular and that extends around the shaft section 18 projecting through the second workpiece 14. Furthermore, material of the second workpiece 14 is also urged into the conically tapering regions of the transition cone 30 of the ring element 16, on the one hand, and of the conical region 74 of the second die 66, on the other hand.

In this way, an effective connection, shown in FIG. 8, with pull-out security is produced between the first and second workpieces 12, 14 and the fastening element 10, wherein the first and second workpieces 12 and 14 contact one another with the lower surface 62 of the first workpiece 12 and an upper surface 87 of the second workpiece 14 after the punching in process in the second setting device 64. The fastening element 10 of the embodiment example shown here can be used for first and second workpieces 12 and 14 having different sheet metal thicknesses.

The end of the shaft section 18 that is remote from the head section 40 and that projects from the second workpiece 14 can be radially expanded, if necessary, to produce an undercut that makes the connection even more reliable.

### REFERENCE NUMERAL LIST

10 fastening element
12 first workpiece
14 second workpiece
16 ring section
18 shaft section
20 opening
22 engagement surface
24 workpiece contact surface
26 punching edge
28 elevated portion
30 transition cone
32 radial outer surface of the ring section 16
34 coupling section
36 outer contour of the shaft section
66 inner contour of the opening 20
40 radially expanded head section
42 groove-like recesses of the shaft section
44 first setting device
46 die
48 passage opening
50 punch
52 contact surface
54 cut-out
56 preloaded workpiece section
58 punching slug
60 component assembly
62 lower surface of the first workpiece 12
64 second setting device
66 second die
68 second passage opening
70 support surface
72 elevated die portion
74 conical region
76 second punch
78 first contact region
79 second engagement surface
80 second contact region
82 second punching slug
83 second punching edge
84 tapering region
85 lower surface 85 of the second workpiece 14
86 recess 86 corresponding to the elevated die portion 72
87 upper surface of the second workpiece 14
L longitudinal axis
A_{S} axial extent of the shaft section 18
A_{R} axial extent of the ring section 16
E punch-in direction

1. A self-punching fastening element for connecting a first workpiece to a second workpiece, said self-punching fastening element comprising:
a ring section that surrounds an opening of the self-punching fastening element in a peripheral direction and that has a workpiece contact surface, which is bounded at a radial outer side by a punching edge, and an engagement surface for a first setting device that is arranged at a side of the ring section remote from the workpiece contact surface; and
a shaft section that is connected to the ring section by means of a coupling section, that is arranged coaxially with the opening, that extends from the side of the ring section remote from the workpiece contact surface, and that has an outer contour that is designed complementary to an inner contour of the opening such that the shaft section can be guided at least partly through the opening after a separation of the connection with the ring section, wherein an axial extent of the shaft section is greater than an axial extent of the ring section.

2. The self-punching fastening element in accordance with claim 1, wherein at least one of the workpiece contact surface and the engagement surface is annular, and/or wherein a basic shape of an outer contour of the ring section is substantially circular.

3. The self-punching fastening element in accordance with claim 1, wherein a radial outer surface of the ring section has at least one feature providing security against rotation.

4. The self-punching fastening element in accordance with claim 1, wherein the workpiece contact surface is sectionally provided with an elevated portion.

5. The self-punching fastening element in accordance with claim 1, wherein the shaft section has at least one recess at its radial outer side, said at least one recess at least sectionally extending in the peripheral direction.

6. The self-punching fastening element in accordance with claim 1, wherein the shaft section has at least one elevated portion at its radial outer side, said at least one elevated portion at least sectionally extending in an axial direction.

7. The self-punching fastening element in accordance with claim 1, wherein the shaft section has a radially expanded head section at its end remote from the ring section, said radially expanded head section at least sectionally projecting over the inner contour of the opening in a radial direction.

8. The self-punching fastening element in accordance claim 1, wherein a base body of the shaft section has a substantially cylindrical shape, and wherein the opening is substantially circular.

9. The self-punching fastening element in accordance with claim 1, wherein the coupling section is designed such that at least one of a friction locking, a bond, and a form fit is established between the shaft section and the ring section.

10. The self-punching fastening element in accordance with claim 1, wherein the shaft section and the ring section comprise different materials.

11. The self-punching fastening element in accordance with claim 1, wherein the shaft section and the ring section are formed in one piece.

12. A component assembly comprising a first workpiece into which a ring section of a self-punching fastening element is punched, said self-punching fastening element comprising:
the ring section that surrounds an opening of the self-punching fastening element in a peripheral direction and that has a workpiece contact surface, which is bounded at a radial outer side by a punching edge, and an engagement surface for a first setting device that is arranged at a side of the ring section remote from the workpiece contact surface; and
a shaft section that is connected to the ring section by means of a coupling section, that is arranged coaxially with the opening, that extends from the side of the ring section remote from the workpiece contact surface, and that has an outer contour that is designed complementary to an inner contour of the opening such that the shaft section can be guided at least partly through the opening after a separation of the connection with the ring section, wherein an axial extent of the shaft section is greater than an axial extent of the ring section.

13. The component assembly in accordance with claim 12, wherein a surface of the first workpiece remote from the fastening element prior to the punching in is arranged substantially flush with the workpiece contact surface in a region adjacent to or adjoining an opening in the first workpiece produced by the punching in.

14. The component assembly in accordance with claim 12, further comprising a second workpiece that contacts the workpiece contact surface, wherein the connection of the shaft section and the ring section provided by the coupling section is separated and the shaft section is arranged in the opening of the ring section such that an end of the shaft section projects into the second workpiece or projects through the second workpiece.

15. The component assembly in accordance with claim 14, wherein a surface of the second workpiece remote from the ring section has a recess that is arranged radially outside and adjacent to the end of the shaft section projecting into the second workpiece or projecting through the second workpiece.

16. The component assembly in accordance with claim 14,
wherein material of the second workpiece is urged into at least one recess that is arranged at a radial outer side of the shaft section.

17. The component assembly in accordance with claim 14, wherein the material of the first workpiece is stronger than the material of the second workpiece at least in a region around the fastening element.

18. A method of manufacturing a component assembly comprising a first workpiece into which a ring section of a self-punching fastening element is punched, said self-punching fastening element comprising:
the ring section that surrounds an opening of the self-punching fastening element in a peripheral direction and that has a workpiece contact surface, which is bounded at a radial outer side by a punching edge, and an engagement surface for a first setting device that is arranged at a side of the ring section remote from the workpiece contact surface; and a shaft section that is connected to the ring section by means of a coupling section, that is arranged coaxially with the opening, that extends from the side of the ring section remote from the workpiece contact surface, and that has an outer contour that is designed complementary to an inner contour of the opening such that the shaft section can be guided at least partly through the opening after a separation of the connection with the ring section, wherein an axial extent of the shaft section is greater than an axial extent of the ring section, said method comprising the steps of:
providing the first workpiece;
punching the ring section of the self-punching fastening element into the first workpiece while producing a punching slug, wherein a first setting device acts on the engagement surface of the ring section on the punching in.

19. The method in accordance with claim 18, wherein the first workpiece is at least locally heated prior to the punching in of the self-punching fastening element.

20. The method in accordance with claim 18, wherein a second workpiece is provided after the step punching the ring section of the self-punching fastening element into the first workpiece or after a step of locally heating the first workpiece prior to the punching in of the self-punching fastening element such that it is in contact with the workpiece contact surface of the ring section of the component assembly, and wherein the shaft section is subsequently pressed through the opening of the ring section and against the second workpiece by means of a second setting device such that an end of the shaft section projects into the second workpiece or projects through the second workpiece (14).

21. The method in accordance with claim 20, wherein the second workpiece is not heated.

22. The method in accordance with claim 20, wherein a punching slug is punched out of the second workpiece on the pressing in of the shaft section.

23. The method in accordance with claim 20, wherein the second setting device first acts on the shaft section to press said shaft section against the second workpiece until the shaft section has reached a desired end position, and wherein the second setting device subsequently acts on the ring section to press the ring section against the second workpiece.

24. The method in accordance with claim 20, wherein the second workpiece is disposed on a die on the pressing in of the shaft section, said die having an elevated portion that projects from a support surface for the second workpiece and that has a radial inner contour that is disposed outside the outer contour of the shaft section in the radial direction.
